(19) United States
(12) Patent Application Publication
(10) Pub. No.: US 2026/0152195 A1
(43) Pub. Date: Jun. 4, 2026

(54) METHOD FOR MONITORING A TECHNICAL SYSTEM, IN PARTICULAR A MOTOR VEHICLE

(71) Applicant: Robert Bosch GmbH, Stuttgart (DE)

(72) Inventors: Andreas Heyl, Weil Der Stadt (DE); Holger Niemann, Ludwigsburg (DE); Marcel Mausser, Asperg (DE); Nicolas Sommer, Remseck (DE)

(21) Appl. No.: 19/405,971

(22) Filed: Dec. 2, 2025

(30) Foreign Application Priority Data
Dec. 3, 2024 (DE) 10 2024 135 812.2

(51) Int. Cl. B60W 50/04; G06F 11/30

(52) U.S. Cl. CPC B60W 50/045; G06F 11/3013; G06F 2201/865

(57) ABSTRACT

A method for monitoring a technical system including a plurality of computing units on which software components can be installed during operation of the technical system. The computing units are monitored based on a monitoring requirement associated with the software components. A device, a computer program product, a storage medium, and a vehicle, are also described.

### BACKGROUND INFORMATION

Safety-related software may only be run on hardware that has at least the required safety integrity for the function to be implemented by the software. If safety-related software or new safety-related functions are subsequently loaded for example into a control unit, for example a control unit of a vehicle, then in order for said software or functions to be used, it must therefore be ensured that this software also only uses hardware secured by the hardware monitoring (Level 3 according to the E-Gas monitoring concept—cf. “Standardized E-Gas Monitoring Concept for Gasoline and Diesel Engine Control Units v6.0”) that corresponds to the required safety integrity.

In particular for vehicles with downloadable software, such as so-called software-defined vehicles (SDVs), this could mean that a quota must be determined in advance for which and how many hardware parts need to be secured in order to support a maximum number of software functions, e.g., dedicated memory areas, dedicated peripheral components, and dedicated hardware accelerators. However, monitoring these hardware components during operation is resource-intensive, for example when memory needs to be checked through writing and reading, or when diagnostic test patterns need to be executed in components (e.g., a GPU). If this hardware components are not used for safety-related functions at all for certain periods of time, it creates unnecessary overhead. On the other hand, downloading safety-related functions would also be limited only to the previously established quota and would thus limit expansion.

Concepts for downloading and installing software components in technical systems, such as vehicles (e.g., so-called over-the-air updates—OTAs), are described in the related art.

There is a need for a flexible method for monitoring technical systems, in particular motor vehicles.

### SUMMARY

A method according to the invention for monitoring a technical system comprising a plurality of computing units on which software components can be installed during operation of the technical system has by comparison the advantage that the computing units are monitored on the basis of a monitoring requirement associated with the software components. Monitoring in this context should be understood in particular to mean monitoring in the sense of Level 3 of the E-Gas concept. This monitoring is advantageously monitoring of the functionality of the computing unit's hardware.

According to an example embodiment, advantageously, the monitoring of the computing units comprises a monitoring computer monitoring a function computer of the computing units. The monitoring computer can monitor the function computer of the computing unit in particular through question-and-answer communication. The monitoring computer can be located outside the computing unit or integrated into the computing unit. The monitoring computer can in particular be a watchdog.

According to an example embodiment, advantageously, the monitoring of the computing units is adapted, in particular activated or deactivated, based on the monitoring requirement. This means that unnecessary monitoring can be avoided, which saves computing resources while simultaneously being able to maintain a high level of safety.

According to an example embodiment, advantageously, the monitoring of the computing units is adapted dynamically during runtime of the installed software components. In particular, the monitoring can be adapted cyclically at fixedly predetermined time intervals.

According to an example embodiment, advantageously, the monitoring of the computing units is adapted after a software component has been installed on one of the computing units. As a result, it can advantageously be ensured that the monitoring is not adapted too frequently and that not too many resources are required to adapt the monitoring. At the same time, the level of safety constantly remains ensured.

According to an example embodiment, advantageously, the adaptation of the monitoring of the computing units comprises checking which components of the computing units must be monitored according to the monitoring requirement associated with the installed software component. In particular in complex computing units comprising for example a plurality of function computers, this means that resource-optimized monitoring of the system can be ensured. The components of the computing unit that are to be monitored may be, for example, a computer core, such as a microcontroller computer core, a memory, or a communication line within the computing unit.

According to an example embodiment, advantageously, the monitoring requirement associated with a software component to be installed is transferred to the technical system together with the software component, in particular as meta-information, before the software component is installed on a computing unit of the technical system.

According to an example embodiment, advantageously, the monitoring requirement associated with a software component to be installed is read out from a database outside the technical system. The database may be, in particular, a database available on the Internet or provided by a manufacturer of the software component. The monitoring requirement associated with a software component to be installed can in particular however also be specified by an authority, for example, a licensing authority.

The method according to the invention is particularly advantageous to apply to motor vehicles. Advantageously, the technical system is therefore a motor vehicle, in particular a so-called software-defined vehicle.

Alternatively or additionally, it may be provided to monitor the computing unit with the aid of additional resources, such as a hardware security module, if the monitoring requirement cannot otherwise be met.

Alternatively or additionally, it may be provided to incorporate monitoring resources from other computing units, such as the vehicle, if the monitoring requirement cannot otherwise be met.

Also advantageous are a device which is configured to carry out each step of the method according to the invention, and a computer program product which, when executed on a computing unit, causes the computing unit to carry out all steps of the method according to the invention.

Also advantageous are a storage medium comprising the computer program product, and a vehicle comprising a computing unit that is configured to carry out the method according to the invention.

An exemplary embodiment of the method according to the invention is presented in more detail below.

### BRIEF DESCRIPTION OF THE DRAWING

FIG. 1 shows a flowchart of an embodiment of the method according to the invention.

### DETAILED DESCRIPTION OF EXAMPLE EMBODIMENTS

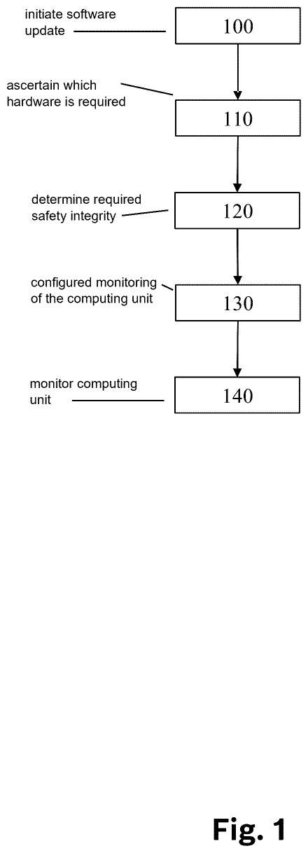

FIG. 1 shows a flowchart of an exemplary embodiment of a method according to the invention. In step 100, a software update is initiated on a computing unit of a vehicle. For this purpose, a software component required for the update, along with a monitoring requirement associated with the software component, is transmitted to the vehicle. The software component may, for example, be software for determining a torque requested by the vehicle. Such a software component is typically associated with a monitoring requirement according to ASIL-D. The monitoring requirement can be transmitted in the form of a safety manifest, preferably in the form of meta-data. Alternatively, the monitoring requirement can however also be downloaded from a database. The database can be located inside or outside the vehicle. Step 110 is carried out after step 100.

In step 110, it is ascertained which hardware is required for the software component transferred in step 110, i.e., which computing unit of the vehicle will run the software component after it has been installed during operation of the vehicle. Step 120 is then carried out.

In step 120, a required safety integrity for the computing unit that will run the software component is determined based on the monitoring requirement associated with the software component. Step 130 is performed after step 120.

In step 130, monitoring of the computing unit ascertained in step 110 is configured based on the safety integrity ascertained in step 120. For example, hardware monitoring of the computing unit can be enabled by a monitoring computer, such as a watchdog. If the monitoring requirement for the computing unit decreases, for example because the newly installed software component is assigned a low monitoring requirement and at the same time an old software component with a high monitoring requirement is uninstalled, the hardware monitoring of the computing unit can also be disabled. Step 140 is then carried out.

The vehicle is operated in step 140. The computing unit is monitored during this process.

The presented exemplary embodiment of the method according to the invention allows vehicles with downloadable software to be monitored flexibly and at the same time in a resource-saving manner, and is therefore advantageous particularly in the context of complex E/E architectures of modern vehicles.

1-13. (canceled)

14. A method for monitoring a technical system, the technical system including a plurality of computing units on which software components can be installed during operation of the technical system, the method comprising:
monitoring the computing units based on a monitoring requirement associated with the software components.

15. The method according to claim 14, wherein the monitoring of the computing units includes a monitoring computer monitoring a function computer of the computing units.

16. The method according to claim 14, wherein the monitoring of the computing units is adapted including being activated or deactivated, based on the monitoring requirement.

17. The method according to claim 16, wherein the monitoring of the computing units is adapted dynamically during runtime of the software components after the software components are installed on at least one of the computing units.

18. The method according to claim 16, wherein the monitoring of the computing units is adapted after a software component of the software components has been installed on one of the computing units.

19. The method according to claim 18, wherein the adapting of the monitoring of the computing units includes checking which components of the computing units must be monitored according to the monitoring requirement associated with the installed software component.

20. The method according to claim 14, wherein the monitoring requirement associated with a software component to be installed is transferred to the technical system together with the software component as meta-information, before the software component is installed on a computing unit of the computing units of the technical system.

21. The method according to claim 14, wherein the monitoring requirement associated with a software component to be installed is read out from a database, outside the technical system.

22. The method according to claim 14, wherein the technical system is a motor vehicle.

23. A device configured to monitor a technical system, the technical system including a plurality of computing units on which software components can be installed during operation of the technical system, the device configured to perform the step comprising:
monitoring the computing units based on a monitoring requirement associated with the software components.

24. A non-transitory storage medium on which is stored a computer program for monitoring a technical system, the technical system including a plurality of computing units on which software components can be installed during operation of the technical system, the computer program, when executed by a computing unit, causing the computing unit to perform the following step comprising:
monitoring the computing units based on a monitoring requirement associated with the software components.

25. A vehicle, comprising:
a computing on which a software component can be installed during operation of the vehicle, the computing unit being monitored based on a monitoring requirement associated with the software component.
